(19) United States
(12) Patent Application Publication
(10) Pub. No.: US 2013/0017609 A1
(43) Pub. Date: Jan. 17, 2013

(54) APPARATUS AND METHOD FOR INDICATING A PHYSICAL OR CHEMICAL PHENOMENON

(71) Applicants: Markku Känsäkoski, Oulu (FI); Eero Hurme, Espoo (FI); Leena Hakalahti, Oulu (FI); Raimo Korhonen, Tampere (FI); Antti Kemppainen, Oulu (FI)

(72) Inventors: Markku Känsäkoski, Oulu (FI); Eero Hurme, Espoo (FI); Leena Hakalahti, Oulu (FI); Raimo Korhonen, Tampere (FI); Antti Kemppainen, Oulu (FI)

(73) Assignee: BASF SE, Ludwigshafen (DE)

(21) Appl. No.: 13/520,098

(22) PCT Filed: Dec. 31, 2009
(86) PCT No.: PCT/FI2009/051052

§ 371 Date: Sep. 21, 2012

(51) Int. Cl. G01N 31/22; G01N 21/78

(52) U.S. Cl. 436/1; 422/50; 422/400

(57) ABSTRACT

The invention relates to an apparatus (200), which comprises a first substance (220) in a microchannel (210) of the apparatus configured to react to a physical phenomenon or chemical phenomenon directed to the apparatus for providing an indication, which originates from the physical phenomenon or chemical phenomenon directed to the apparatus and indicates an occurrence of the physical phenomenon or chemical phenomenon directed to the apparatus. The invention also relates to a method, which is performed by means of the apparatus and a device, which comprises the apparatus.

### TECHNICAL FIELD OF THE INVENTION

The invention relates to an apparatus for indicating a physical phenomenon or chemical phenomenon directed to the apparatus. The invention also relates to a method for indicating the physical phenomenon or chemical phenomenon directed to the apparatus. Furthermore, the invention relates to a device, which comprises the apparatus for indicating a physical phenomenon or chemical phenomenon directed to the apparatus.

### BACKGROUND OF THE INVENTION

The security of the packages becomes more and more important since product counterfeiting is a multi-billion business and brand owners lose annually large sums of money with counterfeit products. For example, in the United States alone more than 1.2 billion digital versatile disks (DVDs) are sold every year. In packages, the most common security solution is a hologram, which is however relatively easy to counterfeit. Typical application areas for holograms are e.g. a tamper evidence, brand protection, and authentication.

Products own security is also important for perishable articles. Especially, this is important for safety of pharmaceutical products, food, food additives, cosmetics, chemicals, or other such products, where the European Union directive requires manufacturers to notify the expiration date of the product usage, i.e. when the useful life of the perishable product lapses, in product packaging. If the perishable product is actually exposed to harmful stimulus being higher/lower than a certain threshold, where the stimulus is caused by a physical or chemical phenomenon including mechanical, radiative or other environmental phenomena, the product may degrade or spoil before a calculated expiration date. For example, the cold chain management of the product needs actual real-time detection of exposure to harmful stimulus through a supply chain to indicate that the product is usable or not.

Surface sensor indicators for food and medical package applications have been on market since 1970-80's. Known time and time-temperature indicators operate by chemical reaction mechanism, diffusion mechanism, and capillary driven fluid wicking mechanism, e.g. the migration of the fluids or gels through wicks to indicate the passage of time or thermal exposure. There are known time and time-temperature indicators that function by flow of a material through the channels of the microstructure substrate.

Liquid based time indicators are used for monitoring a product safety and quality. Labels to be stuck on products contain a liquid dye which, when activated, migrates across a label at a pertinent rate. They are activated by squeezing a start button, which moves the liquid into direct contact with a porous membrane through which the liquid diffuses. Labels can be tailored to different time periods. However, the liquid based time indicators monitor only time but not product adulteration directly.

Time-temperature indicators may operate by a chemical reaction, diffusion, or capillary driven fluid-wicking mechanism. The label comprising time-temperature indicators reacts to temperature changes and time of exposure of the product to temperatures exceeding a critical temperature. In time-temperature indicators two reagents are diluted and placed in two neighboring beds where the two solutions are immobilized. Above a critical temperature (freezing the solutions) a structure that immobilizes the solutions is damaged and exposure to a given temperature during suitable time (melting the solutions), the solutions are no longer immobilized and they can intermingle causing a reaction, which is visible. However, time-temperature indicators react to changes in temperature and time in storage conditions only.

The preceding drawbacks have limited significantly the usability of the existing indicators.

### SUMMARY

Therefore, one object of the invention is to withdraw the above-mentioned drawbacks and provide an apparatus, which actually indicate a physical or chemical phenomenon directed to the apparatus.

One object of the invention is fulfilled by providing an apparatus of claim 1, a method of claim 8, and a device of claim 15.

An embodiment of the present invention relates to an apparatus according to claim 1.

In addition, an embodiment of the present invention relates to a method according to claim 8.

Furthermore, an embodiment of the present invention relates to a device according to claim 15.

Further embodiments are defined in dependent claims.

According to an embodiment of the invention an apparatus comprises a first substance in a microchannel of the apparatus configured to react to a physical phenomenon and/or chemical phenomenon directed to the apparatus for providing an indication, which originates from the physical phenomenon and/or chemical phenomenon directed to the apparatus, i.e. said physical phenomenon and/or chemical phenomenon to be detected “activates” the apparatus to operate suitable manner, and indicates an occurrence of the physical phenomenon and/or chemical phenomenon directed to the apparatus (indication of the exposure). The physical phenomenon and/or chemical phenomenon directed to the apparatus comprises at least one physical or chemical phenomenon, but it can also comprise the combination of two or more similar phenomena or disparate phenomena, or the combination of the phenomena comprising at least one phenomenon, which is different than other phenomena among the phenomena combination.

The term “substance” refers to any fluid, solid, porous or gelatinous material, which has particular qualities. Fluid is liquid or gas or any flowable substance comprising moisture, e.g. water, alcohol(s), and/or organic solvent(s). Furthermore, solid material in the microchannel of the apparatus can comprise the structural parts of the microchannel such as a partition wall, column, wall of the microchannel, or reduction element.

The term “microchannel” refers to channels, which has at least one dimension less than 1 millimeter. Such microchannel is e.g. a microchannel, which depth is e.g. dozens of micrometers and width e.g. from dozens of micrometers to centimeters. In microchannels surface tensions and capillary forces dominate instead of gravitation and almost all flows in the microchannels are laminar, which however restrains the mixing of the fluids. The microchannels can be manufactured into e.g. plastic, thermoplastic, silicon, glass, paper, cardboard, wood, metal and/or any fibrous material.

The term “physical phenomenon” refers to the change of the condition relating to e.g. temperature, time, pressure, shock, electrical conductivity, magnetic momentum, and/or tilt.

The term “chemical phenomenon” refers to e.g. a condition where the apparatus is exposed to a certain gas and/or liquid, pH change, concentration, and/or the presence of the analyte. It can also refer to e.g. reduction, oxidation, isomerization, metathesis reaction, and/or chemical decomposition, which will result e.g. the change of the color, crystal structure (volumetric expansion/contraction), scent, etc.

The term “indication” refers to an indication, which can be determined by sense(s) or a suitable device. The indication can comprise e.g. at least one of a visual indication, scent indication, and thermal indication.

According to an embodiment of the invention a method comprises reacting to a physical phenomenon and/or chemical phenomenon directed to an apparatus by means of a first substance in a microchannel of the apparatus for providing an indication, which originates from the physical phenomenon and/or chemical phenomenon directed to the apparatus and indicates an occurrence of the physical phenomenon and/or chemical phenomenon directed to the apparatus.

According to an embodiment of the invention a device, which comprises an apparatus comprising a first substance in a microchannel of the apparatus configured to react to a physical phenomenon and/or chemical phenomenon directed to the apparatus for providing an indication, which originates from the physical phenomenon and/or chemical phenomenon directed to the apparatus and indicates an occurrence of the physical phenomenon and/or chemical phenomenon directed to the apparatus.

The apparatus according to embodiments of the invention offers easy and reliable way to monitor products and/or packages by providing a new generic and versatile solution, which fulfils a number of needs that have arisen in connection with the limitations of the liquid based time indicators and time-temperature indicators.

In addition, the apparatus according to embodiments of the invention enables a reliable and real-life response to a variety of stimuli directed to the apparatus upon an exposure to a physical or chemical phenomenon. A further benefit is a visual, scent, and/or thermal response that can be used to effectively indicate the presence of the harmful stimulus.

Also, the apparatus according to embodiments of the invention offers an opportunity to develop various types of indicators, whose sensitivity is adjustable by mechanic, chemical, and/or fluidic combinations.

Furthermore, the apparatus according to embodiments of the invention provides an easy and reliable security solution to prevent product counterfeit, usability in brand promotional purposes, and low manufacturing costs. It is simple and cost-effective manufacturing process provides suitability for a mass-production and applicability to consumer packages.

The verb “to comprise” is used in this document as an open limitation that neither excludes nor requires the existence of also unrecited features. The verbs “to include” and “to have/has” are defined as to comprise.

The terms “a”, “an” and “at least one”, as used herein, are defined as one or more than one and the term “plurality” is defined as two or more than two.

The term “another”, as used herein, is defined as at least a second or more.

The term “or” is generally employed in its sense comprising “and/or” unless the content clearly dictates otherwise.

For the above-mentioned defined verbs and terms, these definitions shall be applied, unless a different definition is given in the claims or elsewhere in this description/specification.

Finally, the features recited in depending claims are mutually freely combinable unless otherwise explicitly stated.

### BRIEF DESCRIPTION OF THE DRAWINGS

Next, the preferred embodiments of the invention will be described with reference to the accompanying drawings, in which

FIG. 1 illustrates an exemplary flowchart of a method according to a preferred embodiment of the invention,

FIGS. 2a-2b illustrate an exemplary views of an apparatus according to preferred embodiments of the invention,

FIGS. 3a-3b illustrate exemplary views of a microchannel of an apparatus according to a preferred embodiment of the invention,

FIGS. 4a-4c illustrate another exemplary views of a microchannel of an apparatus according to a preferred embodiment of the invention,

FIGS. 5a-5b illustrate exemplary views of a microchannel of an apparatus according to a preferred embodiment of the invention, wherein is used a partition wall in the microchannel structure,

FIGS. 6a-6b illustrate another exemplary views of a microchannel of an apparatus according to a preferred embodiment of the invention, wherein is used a partition wall in the microchannel structure,

FIG. 7 illustrates an exemplary view of an apparatus according to preferred embodiments of the invention, which is used in context of a barcode, and

FIG. 8 illustrates an exemplary view of an apparatus according to preferred embodiments of the invention, which is used in context of a pill sheet.

### DETAILED DESCRIPTION

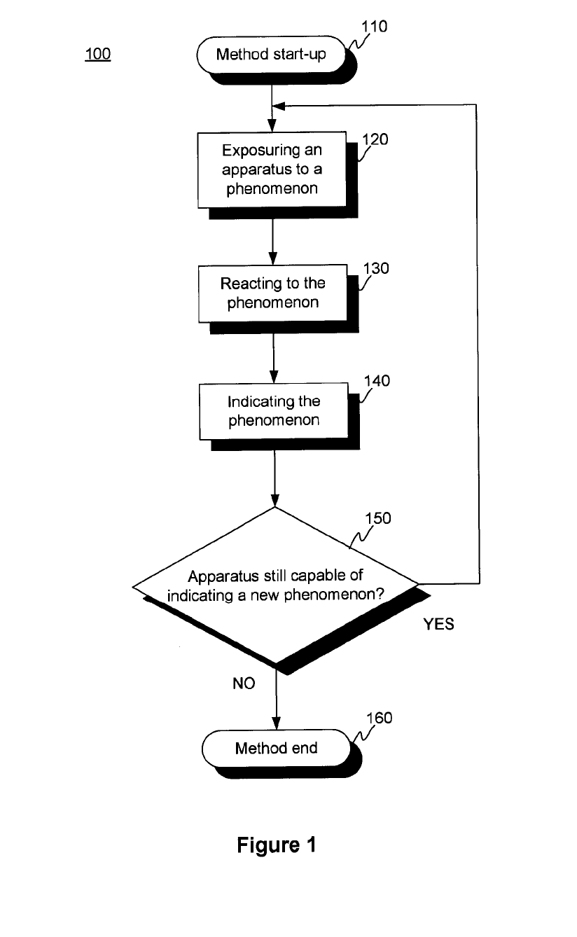

FIG. 1 illustrates a flowchart describing a method 100 according to the embodiment of the invention, which is executed by a detection and indication apparatus, e.g. a microfluidic indicator, according to an embodiment of the invention.

An apparatus according to an embodiment of the invention comprises at least a first substance, which is configured to react to a physical phenomenon and/or chemical phenomenon directed to the apparatus. The first substance is in the microchannel of the apparatus and/or a part of the microchannel and its function is to provide an indication, e.g. a visual indication, which originates from the exposure of the physical phenomenon and/or chemical phenomenon directed to the apparatus. The (visual) indication indicates to an external observer, e.g. a person or device capable to detect the provided (visual) indication, the occurrence of the physical phenomenon and/or chemical phenomenon directed to the apparatus.

During a method start-up in step 110, an apparatus, i.e. a microfluidic indicator, is attached on the surface of the product, e.g. a DVD or software pack, or directly manufactured into a product, e.g. a bar code, logo, or price tag, by a suitable manner. The microfluidic indicator will be exposed to a physical or chemical phenomenon and it is meant to detect and indicate the actuating or actuated physical and/or chemical phenomenon, which directs to the microfluidic indicator. The indication is provided by a substance, i.e. a stationary fluid, which fills only part of the microchannel. The other parts of the microchannel, which form an indication area, contain e.g. air in a prevailing air pressure or pressurized air when the microfluidic indicator is “untouchable”.

Next, in step 120 the microfluidic indicator on the surface of the product or into the product exposures to the physical phenomenon, e.g. it receives an external shock partly destroying the microchannel of the microfluidic indicator or opening a hole into the structure of the microchannel.

In step 130 the microfluidic indicator or part of it reacts due to the shock, which partly destroyed the microchannel or opened the hole into the microchannel structure, so that the fluid in the microchannel moves along the microchannel through the destroyed part or opened hole towards the indication area.

Then, in step 140, the flowing fluid fills the microchannel in the indication area so that a person who checks whether the product (microfluidic indicator) is violated immediately notices by eyes that the fluid fills the microchannel of the indication area, whereupon he/she can conclude that somebody or something has tampered the product. The delay between steps 130 and 140 depends on the type of the microfluidic indicator and phenomenon, and in some cases it is difficult to estimate whether the phenomenon and the indication occur different times.

If the microfluidic indicator is still capable of indicating a new physical and/or chemical phenomenon directs towards the microfluidic indicator, it is possible to return back to step 120 in step 150.

Otherwise, the indication method is ended in step 160.

Consequently, according to an embodiment of the invention a detection and indication method, which is executed by means of a preceding apparatus, comprises the step of reacting to a physical phenomenon and/or chemical phenomenon directed to the apparatus by means of a first substance in the microchannel of the apparatus and/or first substance being a part of the microchannel in order to provide an indication, which originates from the physical phenomenon and/or chemical phenomenon directed to the apparatus and indicates the occurrence of the physical phenomenon and/or chemical phenomenon directed to the apparatus.

Furthermore, according to an embodiment of the invention a device, e.g. a pack, packing, instrument, bar code, logo, tag, or price tag, which comprises a detection and indication apparatus comprising a first substance in a microchannel of the apparatus and/or first substance being a part of the microchannel. The first substance is configured to react to a physical phenomenon and/or chemical phenomenon directed to the apparatus for providing an indication, which originates from the physical phenomenon and/or chemical phenomenon directed to the apparatus and which indicates the occurrence of the physical phenomenon and/or chemical phenomenon directed to the apparatus.

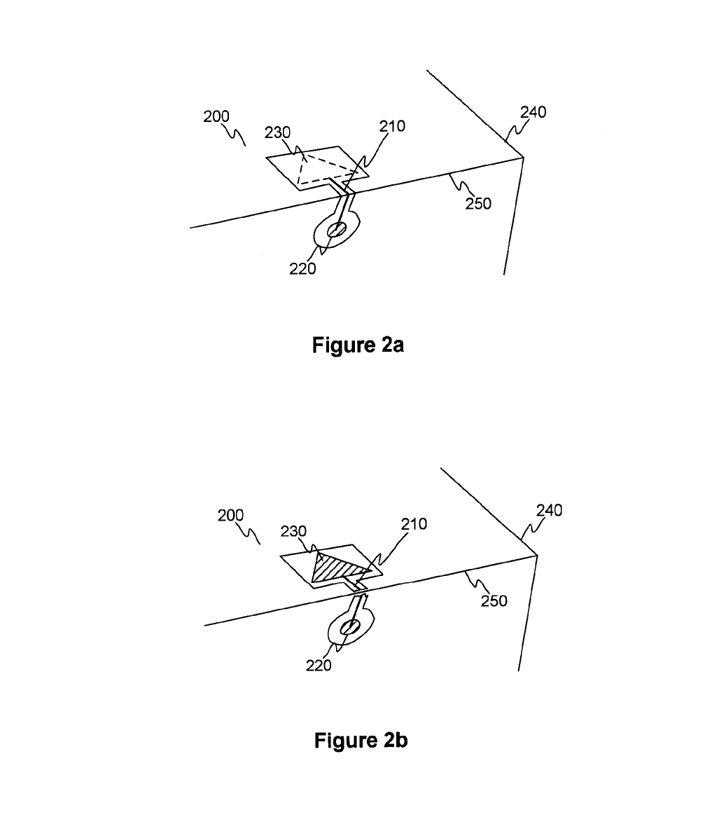

A printed indicator 200, which performs the aforesaid detection and indication method, can simply be a sticker type indicator 200 having a microchannel 210, which is e.g. roll-to-roll hot embossed on thermoplastics and filled up with a visible fluid 220. A flow control in the microfluidic indicators can be provided by means of e.g. pressure difference, hydrofobicity/hydrophilicity, swell gels, and/or state changes. The indicator 200 also comprises an indication area 230, which does not comprise any visible fluid 230 when the indicator 200 is intact. Such indicator is represented in FIG. 2a.

The indicator 200 is based on the control of the indication liquid (or gelatinous material) in a microfluidic structure due to a physical or chemical phenomenon and the simplest structure is a “tamper evidence” device according to the figure, wherein the liquid 230 in the microchannel 210 is stationary, but when the microchannel 210 is broken or a hole (not shown in the figure) is provided into the microchannel 210, the liquid 230 can move by capillary forces and, thereby, one can see that the channel is “broken”. There are several options and combinations, which may comprise, e.g., the microchannel 210 and capillary phenomena can be done by heat-sensitive polymer, using an electric field-sensitive polymer (e.g. the polymer deforms solid and liquid above the phenomena, etc.). Generally, the indicator 200 may comprise a number of different smart polymers (physical response) and microfluidic combinations, and, additionally, a visual observation can be confirmed by a chemical reaction with the fluid 230 arriving in the region of the microchannel, where a printed indicator material or other reactive material (not shown) locates, whereupon, when the fluid 230 reacts with the printed material, the reaction provides the color change of the fluid.

Anyhow, the indicator 200 is stuck on a package 240 including a product on sale so that it partly covers an edge 250, which have to open in order to get the product out of the package 240. If somebody opens the package 240 for seeing what is inside the package 230, he/she similarly breaks the microchannel 210, whereupon the visible fluid 220 in the microchannel 210 propagates to the indication area 230 for producing a visible triangle as one can see from FIG. 2b. Thus, it is possible to notice the visible triangle by eyes and come to a conclusion that the package 230 has been opened even if the breakage of the microchannel would be impossible to detect by eyes. Furthermore, the indicator 200 can also be the opening/closing shutter of the device, which indicates whether the shutter has opened or not.

Respectively, the indication area 230 can contain some substance, which reacts with the incoming (visible) fluid 220, so that the result of the chemical reaction of the some substance and fluid 220 can be smelt by nose. Secondly, the indication area 230 can contain material, which produces a heat when it reacts with the fluid 220, whereupon an observer can detect, even in the dark, the breakage by his/her hand.

According to an embodiment of the invention the apparatus, which is disclosed in the previous embodiment(s), wherein the apparatus is configured to provide the indication by means of at least one of a visual indication, which can be observed by eyes or a suitable device such as a bar code reader or computer scanner, scent indication, which can be detected by means of a nose or suitable gas sensor, and thermal indication observed by sense of touch or suitable device, which is adapted to detect the (surface) temperature of the indicator, e.g. thermographic camera or infrared radiation pyrometer.

Correspondingly, according to an embodiment of the invention the method, which is disclosed in the previous embodiment(s), wherein the method comprises the step of providing the indication by means of at least one of a visual indication, scent indication, and thermal indication.

Also, according to an embodiment of the invention the device, which disclosed in the previous embodiment(s), comprises the apparatus configured to provide the indication by means of at least one of a visual indication, scent indication, and thermal indication.

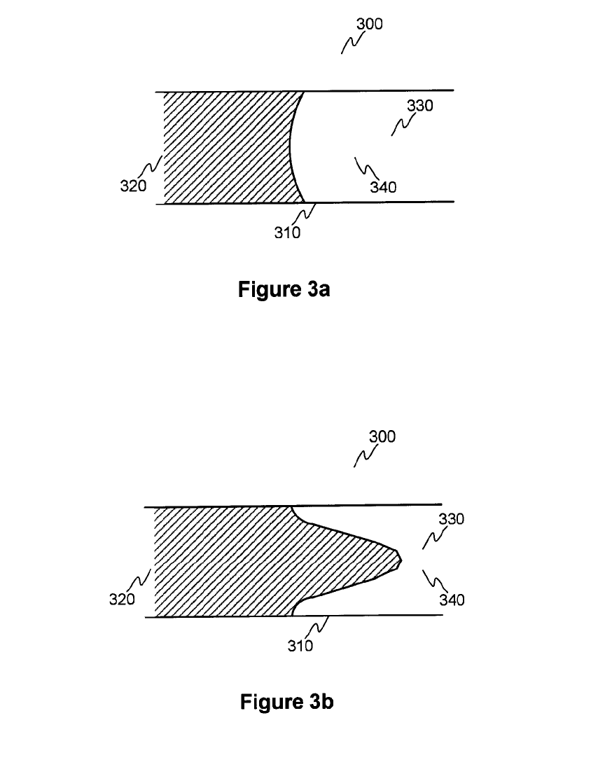

FIGS. 3a-3b show one example to provide the indication of the directed phenomenon, wherein an indicator utilizes a fluid as an indication substance according to the previous figures.

FIG. 3a presents an “untouchable” indicator 300 ready for indicating a phenomenon to which it exposures. The indicator 300 comprises a microchannel 310, which has at least one dimension, e.g. width, length, or depth, less than 1 millimeter, and the cross-section of the microchannel can be e.g. a square, rectangle, V-, semi-parallelogram, or semi-circle shaped. There is depicted only a part of the microchannel 310 in the figure and it continues to both directions outside the figure, where it can e.g. narrow as a smaller microchannel, enlarge as a bigger channel, merge with other channel structure(s), or divide into two or more channels and/or microchannels. The microchannel 310 is filled up partly with a colored indication fluid 320 and partly with e.g. a pressurized air 330, which infuses an indication area 340 receiving the indication fluid 320 after the microfluidic indicator 300 has exposed to the phenomenon.

The indication area 340 can be a part of e.g. a logo or other pattern, and when the phenomenon falls on the indicator 300 and inflicts a hole in the microchannel 310, the colored indication fluid 320 moves into the indication area 340 and other parts of the pattern as FIG. 3b describes. Thus, the desired pattern for indicating the exposure becomes visible because of the colored indication fluid 320. The indication substance 320 can be any suitable fluid, which is capable of running along the microchannel 310.

On the other hand, the pressurized air 330 can act as a separating medium between the indication fluid 320 and another fluid or solid material locating farther ahead in the indication area 340, e.g. in the pattern parts, and after the exposure the indication fluid 320 invades towards the pattern parts for encountering the another fluid or solid material and reacting with it, whereupon the visual indication comprises both the pattern occurrence and the discoloration because of the chemical reaction of the indication fluid 320 and the another fluid or solid material.

According to an embodiment of the invention the apparatus, which is disclosed in any of the previous embodiments, wherein the apparatus comprises the first substance in the microchannel, e.g. a liquid, gelatinous material, gas, and/or solid material, which is configured to interact directly and/or indirectly with a second substance, e.g. a gas such as air in a prevailing air pressure or pressurized air, suitable liquid, gelatinous material, and/or solid material, in the microchannel due to the physical phenomenon and/or chemical phenomenon directed to the apparatus.

According to an embodiment of the invention the method, which is disclosed in any of the previous embodiments, wherein the first substance in the microchannel interacts with a second substance in the microchannel due to the physical phenomenon and/or chemical phenomenon directed to the apparatus.

According to an embodiment of the invention the device, which is disclosed in any of the previous embodiments, comprises the first substance in the microchannel configured to interact with a second substance in the microchannel due to the physical phenomenon and/or chemical phenomenon directed to the apparatus.

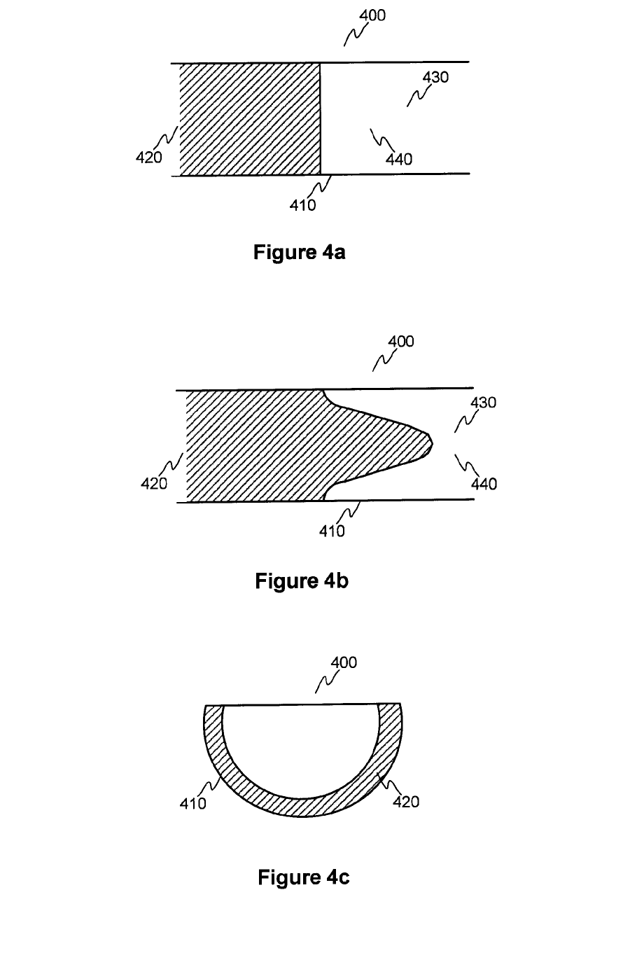

FIG. 4a illustrates another embodiment of the microfluidic indicator 400 having a microchannel 410, which involves at least one dimension less than 1 millimeter. Again the figure includes only a small part of the microchannel 410, which continues to both directions outside the figure.

Anyway, in this particular figure, the microchannel 410 is filled up partly with an indication substance 420, such as a temperature sensitive solid material, and partly with e.g. a pressurized air 430, which infuses an indication area 440 to which the indication substance 420 is meant to propagate after the microfluidic indicator 400 has exposed to the phenomenon. The indication area 440, which is filled up with the pressurized air 430, can be a part of a pattern. The indication substance 420 can be any suitable material, which is sensitive to temperature changes. For example, if the surrounding temperature exceeds a certain threshold temperature, the solid material turns as a fluid, which is capable of running along the microchannel 410.

The rise of the temperature of the immediate surroundings of the microfluidic indicator, which forms the phenomenon directing towards the indicator 400, poses that the solid material in the microchannel 410, which act as an indication substance 420, turns into a fluid. After the exposure to the phenomenon, the indication fluid 420 flows into the indication area 440, whereupon, when the fluid 420 is visually detectable, a person or device capable of detecting this visual indication notices that the fluid 420 has invaded into the indication area 440 and that the temperature has exceeded the threshold temperature. Naturally, the substance 420 can be such material, which also changes its color if the temperature exceeds another temperature limit. This way it is possible to observe the breakdown of the cold chain of the food, cosmetics, or pharmaceutical products during transportation.

Furthermore, FIG. 4c shows one way to realize the solid indication material 420 into the semi-circle shaped microchannel 410, where the indication material 420 forms a layer on the inner surface of the microchannel.

Thereby, according to an embodiment of the invention the apparatus, which is disclosed in any of the previous embodiments, wherein the first substance, e.g. a solid or gelatinous material, in the microchannel is configured to change its state from one state to another state, e.g. from a solid state to a liquid state or from the solid state to a gas state, due to the physical phenomenon and/or chemical phenomenon directed to the apparatus.

According to an embodiment of the invention the method, which is disclosed in any of the previous embodiments, wherein the first substance in the microchannel changes a state from one state to another state due to the physical phenomenon and/or chemical phenomenon directed to the apparatus.

According to an embodiment of the invention the device, which is disclosed in any of the previous embodiments, wherein the apparatus has the first substance in the microchannel, which is configured to change a state from one state to another state due to the physical phenomenon and/or chemical phenomenon directed to the apparatus.

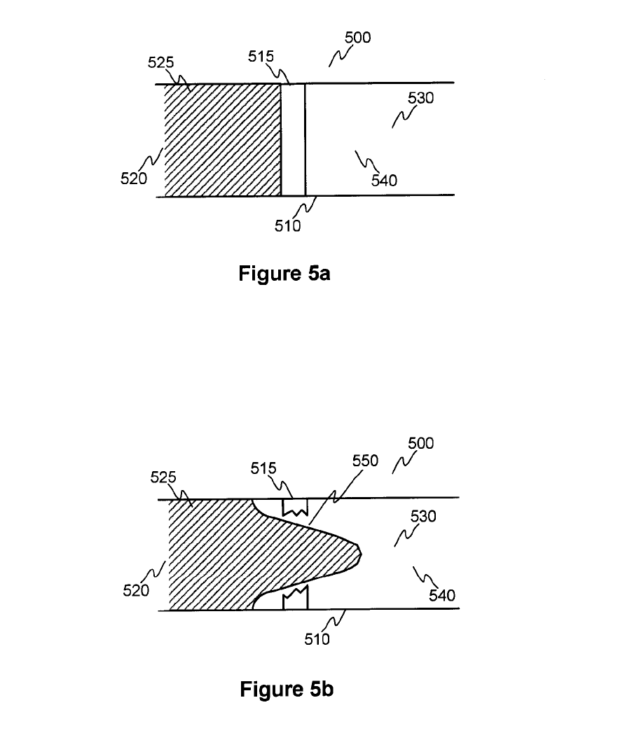

FIGS. 5a-5b show an example how to utilize a partition wall structure in a microfluidic indicator according to the invention.

In FIG. 5a is disclosed one embodiment of the invention, wherein an indicator 500 is also equipped to indicate a phenomenon to which it exposures. The indicator 500 has a microchannel 510, which, for one, comprises a partition wall 515 made of a same material as the microchannel 510.

The partition wall 515 divides the microchannel 510 when the indicator 500 is untouchable into a fluid area 525, where an indication fluid 520 locates, and an indication area 540, which is filled with air 530 and which can be a part of a logo pattern.

A physical or chemical phenomenon, which directs towards the indicator 500 poses the breakage of the partition wall in the microchannel 510 as one can see from FIG. 5b. After the exposure to the physical or chemical phenomenon, the indication fluid 520 flows through a breakage-born hole 550 into the indication area 540, whereupon, when the fluid 520 is visually detectable, a person or device capable of detecting this visual indication notices that the fluid 520 has invaded into the indication area 540 and the exposure to the physical or chemical phenomenon has occurred.

Secondly, the partition wall 515 can divide the untouchable microchannel 510 into the first part 525 comprising a first indication fluid 520 and the second part 540, which comprises a second indication fluid 530 and which can be a part of a pattern.

After the exposure to the physical or chemical phenomenon, the first indication fluid 520 flows through the breakage-born hole 550 in the partition wall 515 into the second part 540 and mixes with the second indication fluid 530, whereupon during the mixing process a chemical reaction between the fluids 520, 530 creates a visually detectable color change in the mixture, a scent detectable by a human nose or suitable device, or thermal phenomena such as the temperature rise or lowering in the surface of the microchannel structure (indicator).

Thus, according to an embodiment of the invention the apparatus, which is disclosed in any of the previous embodiments, wherein the first substance in the microchannel is a partition wall configured to separate the second substance and a third substance from each other.

According to an embodiment of the invention the method, which is disclosed in any of the previous embodiments, wherein the first substance in the microchannel is a partition wall, which separates the second substance and a third substance from each other.

According to an embodiment of the invention the device, which is disclosed in any of the previous embodiments, comprises the apparatus wherein the first substance in the microchannel is a partition wall configured to separate the second substance and a third substance from each other.

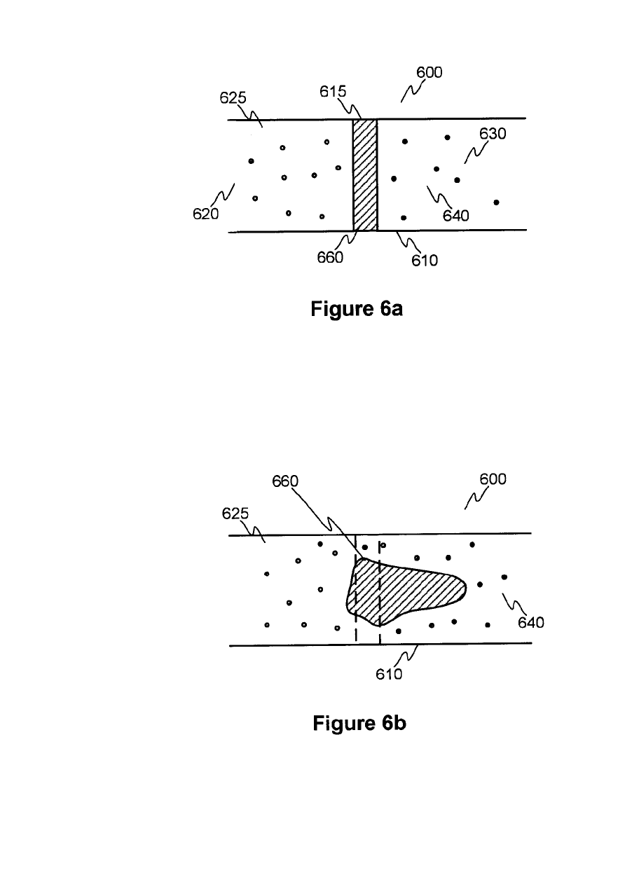

Next, in FIG. 6, is illustrated a microfluidic indicator 600, where a partition wall 615 is manufactured into a microchannel 610 and it consist of a solid material 660, which can be e.g. a temperature sensitive material. The partition wall 615 divides the microchannel 610, similarly as the partition wall of FIG. 5a, into a first part 625 comprising a first indication fluid 620 and a second part 640, which comprises a second fluid 630 and which can be a part of a logo pattern or form a passage to the logo pattern.

When a temperature in the immediate surroundings of the microfluidic indicator 600 exceeds a certain temperature limit, the wall material 660 changes its state from the solid state to a liquid state and, if the fluids 620, 630 are e.g. an air, the liquid 660 alone acts as an indication liquid and starts to move towards the logo pattern according to FIG. 6b. If the fluid 620 also is liquid, it can react with the fluid 660 for producing a color change and the mixture can propagate along the microchannel 610 towards the logo pattern area or it can flow together with the fluid 660 without reacting with each other into the logo pattern area.

Secondly, it is possible that the temperature change does not remove the whole wall material 660 from the microchannel 610 but it incurs a hole in the wall material 660, whereupon the fluid 620, which in this case is e.g. a colored liquid, can flow through the hole into the second microchannel part 640 and towards the logo pattern for providing the indication relating to the occurrence of the temperature change.

According to an embodiment of the invention the apparatus, which is disclosed in any of the previous embodiments, wherein the first substance or third substance in the microchannel is configured to flow, e.g. capillary, along the microchannel due to the physical phenomenon and/or chemical phenomenon directed to the apparatus.

According to an embodiment of the invention the method, which is disclosed in any of the previous embodiments, wherein the first substance or third substance in the microchannel flows along the microchannel due to the physical phenomenon and/or chemical phenomenon directed to the apparatus.

According to an embodiment of the invention the device, which is disclosed in any of the previous embodiments, comprises the apparatus, wherein the first substance or third substance in the microchannel is configured to flow along the microchannel due to the physical phenomenon and/or chemical phenomenon directed to the apparatus.

In one embodiment of the invention, the indicator 600 comprises the logo pattern area, wherein channels forming the logo pattern are coated with a substance. The fluids 620, 660 or 620, 630, 660 react with each other after the temperature has exceed the certain temperature limit and the wall material has changed its state from the solid state to the liquid state at least partly so that the fluid 620 can arrive into the second area 640. The chemical reaction between the fluids 620, 660 or 620, 630, 660 provides a new fluid mixture, which flows along the microchannel 610 to the logo pattern area coated with the substance, and when the fluid mixture reaches the logo pattern area, it reacts with the substance and the reaction provides further indication such as a color change, which an observer can detect by eyes or suitable optical reading machine.

According to an embodiment of the invention the apparatus, which is disclosed in any of the previous embodiments, wherein the first substance and/or third substance flowing in the microchannel is configured to react with the second substance and/or other substance in the microchannel for accomplishing a color change in at least one of the first substance, third substance, second substance, and other substance in order to indicate the physical phenomenon and chemical phenomenon directed to the apparatus.

According to an embodiment of the invention the method, which is disclosed in any of the previous embodiments, wherein the first substance and/or third substance flows in the microchannel reacts with the second substance and/or other substance in the microchannel for accomplishing a color change in at least one of the first substance, third substance, second substance, and other substance in order to indicate the physical phenomenon and/or chemical phenomenon directed to the apparatus.

According to an embodiment of the invention the device, which is disclosed in any of the previous embodiments, comprises the apparatus, wherein the first substance and/or third substance flowing in the microchannel is configured to react with the second substance and/or other substance in the microchannel for accomplishing a color change in at least one of the first substance, third substance, second substance, and other substance in order to indicate the physical phenomenon and chemical phenomenon directed to the apparatus.

The microfluidic indicator according to one embodiment of the invention can be utilized in context of codes, such as barcodes or two dimensional (2D) codes, whereupon the microfluidic indicator is combined with or within a code. The indicator can be produced by printing, so, the manufacturing costs of such indicator are low and it can be applied easily to consumer packages.

Anyway, the microchannel of the indicator, which forms the code or part of it, is filled up with a fluid and when the indicator, i.e. the fluid in the microchannel, reacts to e.g. temperature, time, pressure, shock, or tilt, the fluid changes its color and, thus, changes the content or appearance of the code. In the case of the bar code, the color change can destroy the barcode, make it readable, or change the content of the barcode, whereupon the exposure to the phenomenon can be observed by means of a suitable barcode reader.

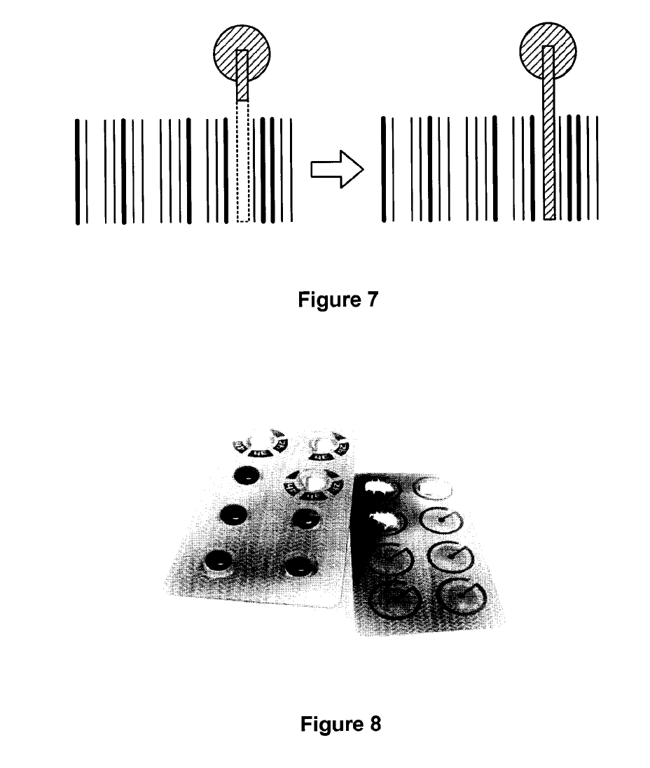

In FIG. 7 is presented a simple example how an indicator according to the embodiment of the invention, which comprises microchannel and a visible liquid, is used to tune (deactivate) the content or readability of the conventional printed barcode. The microchannel is filled up with the visible liquid so that the barcode is erased as unreadable after the exposure to the external phenomenon.

It is possible to integrate several indicators, which indicate different phenomena such as time, temperature, and humidity, into single barcode and if one indicator, e.g. temperature indicator, exposures to a phenomenon, it changes the content of the barcode. Consequently, when a barcode scanner reads the barcode, it indicates that the particular phenomenon has occurred.

A visual effect in packages provided by a microfluidic indicator according to one embodiment of the invention can be further utilized in context of e.g. logos, texts, and images, when a reaction to a phenomenon is indicated visually (a logo will appear, color of the logo changes, part of the image becomes visible, text changes its color, etc.).

For example, a colored liquid in the indicator moves into microchannels forming a logo because of the exposure of the phenomenon, e.g. due to a pressure (membrane pump), so that the colored liquid fills the logo channels and provides that the logo becomes visible. On the other hand, the phenomenon can pose a reaction between two substances, whereupon the logo changes its color. In addition, this can be modified e.g. by using pressure to bring a reagent, which modifies the colored liquid in the microchannels. Also, the fluid movement, e.g. waves, in the microchannels can be provided by applying pressure waves, e.g. music, through. Options to implement indicators according to the embodiments of invention are unlimited and this document describes only a few of possible implementations.

Furthermore, an indicator according to the embodiment of the invention can be utilized in context of time strips as one can see from FIG. 8. Each pill in a pill sheet has a microchannel, which is adapted to indicate a lapse of time. So, when a pill is taken out from the pill sheet, the microchannel relating to the taken pill opens and starts a process in the “timer”. Therefore, a user may easily follow the lapse of time from the taking of the previous pill and doctor's instructions or medical prescription.

An indicator according to the embodiments of the invention is also suitable for tilt indicators, shock sensors, pressure sensors, and greeting cards just name but a few.

The invention has been now explained above with reference to the aforesaid embodiments and the several advantages of the invention have been demonstrated. It is clear that the invention is not only restricted to these embodiments, but it comprises all possible embodiments within the spirit and scope of the invention thought and the following patent claims.

1. An apparatus comprising
a first substance in a microchannel of the apparatus configured to react to a physical phenomenon or chemical phenomenon directed to the apparatus for providing an indication, which originates from the physical phenomenon or chemical phenomenon directed to the apparatus and indicates an occurrence of the physical phenomenon or chemical phenomenon directed to the apparatus.

2. The apparatus of claim 1, wherein the apparatus is configured to provide the indication by means of a visual indication, scent indication, or thermal indication.

3. The apparatus of claim 1 or 2, wherein the first substance in the microchannel is configured to interact with a second substance in the microchannel due to the physical phenomenon or chemical phenomenon directed to the apparatus.

4. The apparatus of any of claims 1-3, wherein the first substance in the microchannel is configured to change a state from one state to another state due to the physical phenomenon or chemical phenomenon directed to the apparatus.

5. The apparatus of any of claims 1-4, wherein the first substance in the microchannel is a partition wall configured to separate the second substance and a third substance from each other.

6. The apparatus of any of claims 1-5, wherein the first substance or third substance in the microchannel is configured to flow along the microchannel due to the physical phenomenon or chemical phenomenon directed to the apparatus.

7. The apparatus of any of claims 1-6, wherein the first substance or third substance flowing in the microchannel is configured to react with the second substance or other substance in the microchannel for accomplishing a color change in the first substance, third substance, second substance, or other substance in order to indicate the physical phenomenon or chemical phenomenon directed to the apparatus.

8. A method comprising
reacting to a physical phenomenon or chemical phenomenon directed to an apparatus by means of a first substance in a microchannel of the apparatus for providing an indication, which originates from the physical phenomenon or chemical phenomenon directed to the apparatus and indicates an occurrence of the physical phenomenon or chemical phenomenon directed to the apparatus.

9. The method of claim 8, which comprises providing the indication by means of a visual indication, scent indication, or thermal indication.

10. The method of claim 8 or 9, wherein the first substance in the microchannel interacts with a second substance in the microchannel due to the physical phenomenon or chemical phenomenon directed to the apparatus.

11. The method of any of claims 8-10, wherein the first substance in the microchannel changes a state from one state to another state due to the physical phenomenon or chemical phenomenon directed to the apparatus.

12. The method of any of claims 8-11, wherein the first substance in the microchannel is a partition wall, which separates the second substance and a third substance from each other.

13. The method of any of claims 8-12, wherein the first substance or third substance in the microchannel flows along the microchannel due to the physical phenomenon or chemical phenomenon directed to the apparatus.

14. The method of any of claims 8-13, wherein the first substance or third substance flowing in the microchannel reacts with the second substance or other substance in the microchannel for accomplishing a color change in the first substance, third substance, second substance, or other substance in order to indicate the physical phenomenon or chemical phenomenon directed to the apparatus.

15. A device, which comprises the apparatus of any of claims 1-7.
